(19) United States
(12) Patent Application Publication
(10) Pub. No.: US 2003/0091038 A1
(43) Pub. Date: May 15, 2003

(54) Asynchronous N X M arbitrating switch and associated method

(76) Inventor: Michael S. Hagedorn, Orlando, FL (US)

Correspondence Address: Steptoe & Johnson LLP, Attn: Stuart T.F. Huang, 1330 Connecticut Avenue, NW, Washington, DC, 20036, US

(21) Appl. No.: 09/986,665

(22) Filed: Nov. 9, 2001

(51) Int. Cl. H04L 12/50

(52) U.S. Cl. 370/359; 370/536

(57) ABSTRACT

A switch for routing information to one of a first and second outputs, respectively, is provided. The switch includes first and second multi-rail control paths, first and second mutex gates, and first and second demultiplexers. The first and second multi-rail control paths are cross connected into the first and second gates. Outputs of the first and second mutex gates are cross connected into the first and second demultiplexers. First and second data paths input to the first and second demultiplexers, respectively. Data on at least one the first and second data paths is routed to one of the first and second outputs based upon a state of the outputs of the first and second mutex gates.

### BACKGROUND OF THE INVENTION

1. Field of the Invention

The present invention relates to an electronic switch. More particularly, the present invention relates to an arbitrating switch operable under asynchronous control and capable of routing simultaneously received data.

2. Discussion of Background Information

In the field of electronics, arbiters are circuits that determine which of several events occur first. An arbiter circuit element with multiple inputs determines which input receives data first. However, the arbiter outputs are metastable (i.e., have only minimal stability), which often leads to their minimal use in circuits.

A positive logic mutex gate (“mutex”) described by C. L. Seitz, the structure and representation of which are shown in FIGS. 1 and 2, respectively, can act as an arbiter, but with stable outputs. A mutex of this type operates according to the following parameters:

(1) If REQUEST A (RA) and REQUEST B (RB) are both inactive, then GRANT A (GA) and GRANT B (GB) will also be inactive.

(2) If REQUEST A is active while REQUEST B is inactive, then GRANT A will be active and GRANT B will be inactive; REQUEST A is thus granted.

(3) If REQUEST A is inactive while REQUEST B is active, then GRANT A will be inactive and GRANT B will be active; REQUEST B is thus granted.

(4) If REQUEST A and REQUEST B are active simultaneously, then only one of GRANT A and GRANT B will be active, while the other is inactive. The selection of the active output is random, but can be influenced by external conditions (e.g., temperature) or construction irregularities.

Asynchronous circuits have been proposed that are intended to operate without a clock. One asynchronous logic paradigm is disclosed in U.S. Pat. No. 5,305,463 (“the '463 logic system”) which is incorporated herein by reference in its entirety. Several data representations are discussed, but in one representation, a signal may assume a DATA value or a NULL value. A DATA value, for example might be a numeric value ZERO or ONE, or a logic value TRUE or FALSE, or another meaning not related to binary or Boolean logic representations.

In such a representation, a binary signal may take the form of two signal lines, with a first signal lines designated to mean ZERO or FALSE, and the second signal lines designated to mean ONE or TRUE. Each path may assume one of two states: “ASSERTED” or “NULL.” The meaning of the pair of signal lines is determined by the states of the lines. The pair of lines together represents a single binary variable (such as a single bit of binary data) and have four possible states: (1) ASSERTED, ASSERTED, (2) ASSERTED, NULL, (3) NULL, ASSERTED, and (4) NULL, NULL.

The first state (ASSERTED/ASSERTED) is not permitted. The second state (NULL/ASSERTED) represents/signifies meaningful data of a value ZERO or FALSE. The third state (ASSERTED/NULL) represents/signifies meaningful data of value ONE or TRUE. The fourth state (NULL/NULL) lacks meaning, but can be thought of as indicating that the variable is in a NULL state and has not assumed a meaningful value.

This representation is known as a multi-rail representation in Null Convention Logic (“NCL”). Dual-rail representation (i.e., two signal lines with three states NULL, DATA ZERO and DATA ONE) is a specific sub-set of multi-rail representation. As used herein, DATA collectively refers to DATA ZERO and DATA ONE for a dual rail representation (and for any other DATA X states for multi-rail paths with three or more signal lines).

In certain embodiments of the '463 logic system, signals cycle between NULL and DATA values at rates determined primarily by (1) the availability of complete data and (2) the switching speeds of the underlying physical devices. Periods of NULL separate periods of DATA, thus differentiating between different time values of the signals. Fixed-period clocks are not used to regulate the presentation of input signals to a circuit or to regulate the latching of output signals.

### SUMMARY OF THE INVENTION

At present, there is no known asynchronous arbitrating switch that can operate with multi-rail signals.

The present invention provides an arbitrating switch that can operate asynchronously, i.e., independently of any periodic clock. Preferably, the control signals for routing a data stream through the switch are part of the data stream itself. The use of MUTEX gates provides an exclusivity feature that can both receive multi-rail signals and resolve collisions.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a circuit schematic of a mutex gate;

FIG. 2 is a circuit element representation of a mutex gate;

FIG. 3 is a circuit schematic of 2×2 switch according to an embodiment of the invention;

FIG. 4 is a table of data levels progressing through the circuit of FIG. 3;

FIG. 5 is a circuit schematic of a 2×2 switch with acknowledge capability according to another embodiment of the invention;

FIG. 6 is a block diagram of a switch in combination with analyzers according to yet another embodiment of the invention;

FIGS. 7 and 8 are block diagrams of a 4×4 switch according to still another embodiment of the invention;

FIG. 9 is a block diagram of an 8×8 switch according to an embodiment of the invention;

FIGS. 10 and 11 are circuit diagrams of 2×4 switches with acknowledge capability according to other embodiments of the invention.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

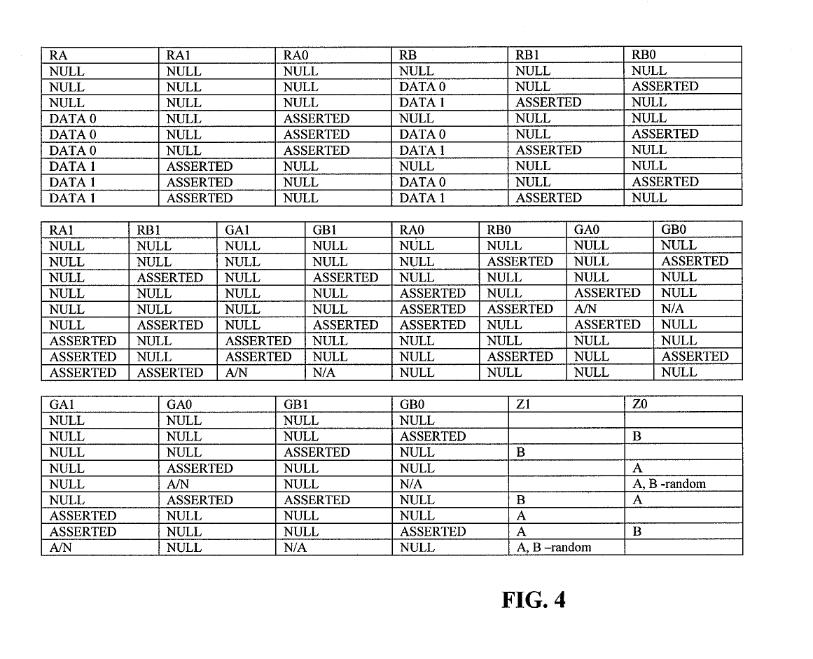

FIG. 3 illustrates a 2×2 arbitrating switch 100 that has four (4) inputs and two (2) outputs. A first data path A_DATA and a second data path B_DATA transmit data into the switch 100, and can emerge at either first output Z1 or first output Z0 (respectively). Request inputs RA and RB are NCL multi-rail paths (dual-rail paths in this embodiment) with dual rail path pairs RA_{—}1, RA_{—}0, and RB_{—}1, RB_{—}0, respectively. Dual-rail signals on RA and RB represent a request to route an associated data signal on data paths A and/or B to either the first or second outputs Z1 and Z0. While data paths A and B, and outputs Z1 and Z0 are represented for ease of discussion by individual paths, these paths are preferably multi-rail signals, and particularly dual-rail signals.

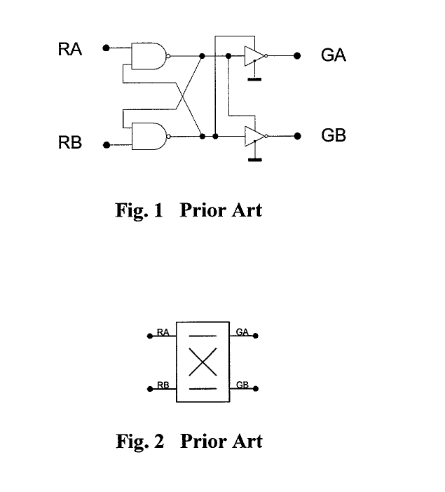

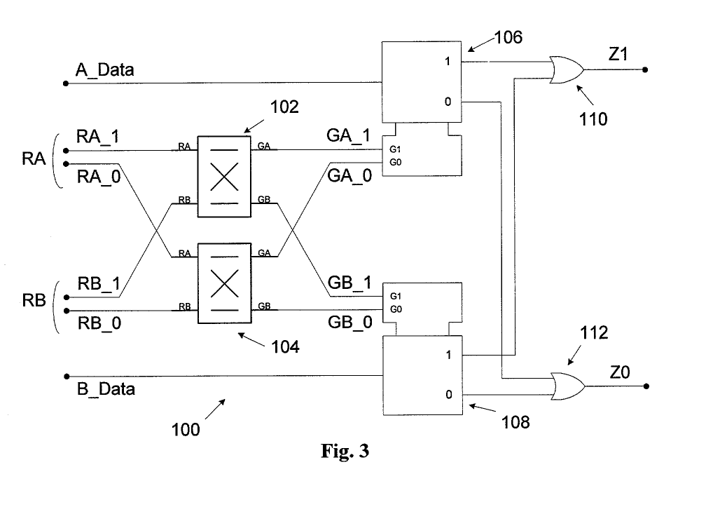

Switch 100 includes a first mutex 102, a second mutex 104, a first demultiplexer 106, a second demultiplexer 108, a first OR gate 110, and a second OR gate 112. Mutexes 102 and 104 are preferably positive logic mutexes as shown in FIGS. 1 and 2, although other mutex designs may be used.

Dual-rail paths RA and RB cross connect into mutexes 102 and 104, such that the “RX_{—}1” paths RA_{—}1 and RB_{—}1 connect to the inputs of mutex 102, while “RY_{—}0” paths RA_{—}0 and RB_{—}0 connect to the inputs of mutex 104. The outputs of mutex 102 and 104 cross-connect to demultiplexers 106 and 108, such that the “GA_X” outputs GA_1 and GA_0 input to demultiplexer 106, while “GB_X” outputs GB_1 and GB_0 input to demultiplexer 108.

If either of GA1 or GB1 is ASSERTED, then data on the corresponding data path A_DATA or B_DATA will route through first OR gate 110 to output Z1. Similarly, if either GA_0 or GB_0 is ASSERTED, then data on the corresponding data path A_DATA or B_DATA will route through OR gate 112. As discussed below, the outputs of the mutexes 106 and 108 are mutually exclusive, such that GA_1 and GB_1 cannot both be TRUE at the same time; similarly, GA_0 and GB_0 cannot both be TRUE at the same time. This mutual exclusion of values prevents signals on data paths A_DATA and B_DATA from colliding at the same output.

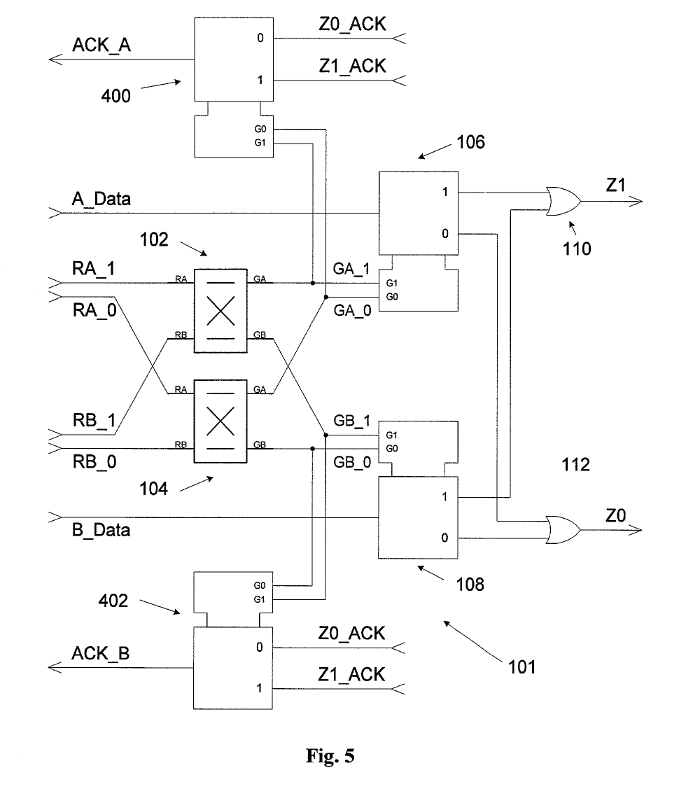

Consistent with the above, there are nine (9) possible combinations of inputs. The step-by-by step flow of data is shown in FIG. 4. The inputs and outputs are preferably null convention logic paths, and particularly dual-rail path, for RA and RB as follows:

| | | | | | | Z1 | Z0 |
|---|---|---|---|---|---|---|---|
| No. | RA_1 | RA_0 | RB_1 | RB_0 | Meaning | output | output |
| 1 | N | N | N | N | No data on paths A or B | N | N |
| 2 | N | N | N | A | No data on path A | N | B |
| | | | | | Request to route data on | | |
| | | | | | data path B to Z0 | | |
| 3 | N | N | A | N | No data on data path A | B | N |
| | | | | | Request to route data on | | |
| | | | | | data path B to Z1 | | |
| 4 | N | A | N | N | Request to route data on | N | A |
| | | | | | data path A to Z0 | | |
| | | | | | No data on path B | | |
| 5 | N | A | N | A | Request to route data on | N | A, B |
| | | | | | data path A to Z0 | | |
| | | | | | Request to route data on | | |
| | | | | | data path B to Z0 | | |
| 6 | N | A | A | N | Request to route data on | B | A |
| | | | | | data path A to Z0 | | |
| | | | | | Request to route data on | | |
| | | | | | data path B to Z1 | | |
| 7 | A | N | N | N | Request to route data on | A | N |
| | | | | | data path A to Z1 | | |
| | | | | | No data on path B | | |
| 8 | A | N | N | A | Request to route data on | A | B |
| | | | | | data path A to Z1 | | |
| | | | | | Request to route data on | | |
| | | | | | data path B to Z0 | | |
| 9 | A | N | A | N | Request to route data on | A,B | N |
| | | | | | data path A to Z1 | | |
| | | | | | Request to route data on | | |
| | | | | | data path B to Z1 | | |

where:

N represents a NULL (i.e., a lack of meaningful data); and

A represents ASSERTED (i.e., the meaning of the path is asserted).

The above table demonstrates that switch 100 responds to a request to route a single data signal (conditions 2-4 and 7) by routing that data signal to the desired output. Switch 100 also responds to simultaneous requests to route data signals on data paths A_DATA and B_DATA to the desired outputs (conditions 6 and 8) without collision.

A collision exists in the simultaneous presence of requests to route both data paths A and B to the same output. Resolution of the collision depends upon the timing of the receipt of the signals. If the signals are sufficiently separated in time that arbitrating switch can determine which arrives first, then the arbitrating switch will resolve the conflict by giving priority to the first signal to arrive, and will not process the latter signal until the first is sent to its destination.

By way of non-limiting example, arbitrating switch 100 receives a Request to route data on data path A to Z1 (condition 7), followed by a Request to route data on data path B to Z1 (condition 3). Since condition 7 exists first, mutex 102 asserts output GA_1, holds output GB_1 NULL. The asserted GA_1 output demultiplexer 106 enables it to route data on path A_DATA to output Z1, while the NULL output on path GB_1 to demultiplexer 108 blocks data on path B_DATA from reaching output Z1. Once the signal on data path A DATA routes through switch 100, RA returns to NULL. (This return to NULL is a convention that is preferably implemented by circuitry outside the switch 100.) Input conditions thus change from condition 7 to condition 3, such that data on data path B then routes to output Z1. As a result, data on both of data paths A DATA and B_DATA will have to pass to the desired output, albeit sequentially and in the order received.

Conditions 5 and 9 correspond to the special case of colliding requests of substantially simultaneous receipt of requests to route both data paths A and B to the same output (i.e., the requests are so close in time that switch 100 cannot determine which of the two arrived first). One of the mutexes 102 or 104 will respond by randomly setting one of its G outputs to ASSERTED, and the other G output to NULL, such that the data signal on only one of the data paths A and B will be routed. (The operative mutex depends on which output received the colliding requests.)

By way of non-limiting example, condition 9 represents simultaneous requests to route data on data paths A_DATA and B_DATA to output Z1. Rail paths RA_{—}1 and RB_{—}1 are both ASSERTED. Mutex 102 asserts output GA_{—}1 (randomly), and leaves output GB_1 NULL. The asserted GA_1 output demultiplexer 106 enables it to route data on path A_DATA to output Z1, while the NULL output on path GB_1 to demultiplexer 108 blocks data on path B_DATA from reaching output Z1. Once the signal on data path A_DATA routes through switch 100, RA returns to NULL. (This return to NULL is a convention that is preferably implemented by circuitry outside the switch 100.) Input conditions thus change from condition 9 to condition 3, such that data on data path B then routes to output Z1. As a result, data on both of data paths A_DATA and B_DATA will have to pass to the desired output, albeit sequentially and in a random order.

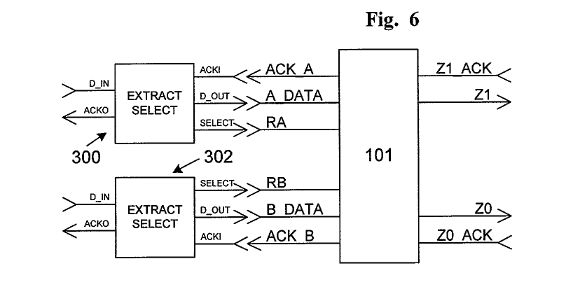

FIG. 5 illustrates a 2×2 arbitrating switch 101 similar to that of FIG. 3 but with additional circuitry for generating “acknowledge” which are useful in asynchronous circuitry. Signals Z0_ACK and Z1_ACK are acknowledge signals (preferably single-rail) from a downstream circuit element that represent/confirm receipt of ASSERTED data and NULL signals from the outputs of Z0 and Z1. U.S. Pat. No. 5,896,541 (incorporated herein by reference in its entirety) illustrates use of acknowledge signals in larger circuit structures. Each signal Z0_ACK, Z1_ACK passes through one of the multiplexers 400 and 402, the outputs of which are controlled by Mutex outputs GA and GB, respectively, to generate A_ACK and B_ACK acknowledge signals. Preferably, an upstream circuit that provides the data stream for data paths A_DATA and B_DATA (e.g., analyzers 300 and 302 discussed below) will maintain their states until A_ACK and/or B_ACK indicate that the data signal has been properly routed, such that new data may be sent to switch 101. In an alternative embodiment, OR gates that only receive GA and GB can be used instead of multiplexers 400 and 402 to create an acknowledgement of the selection of the output path.

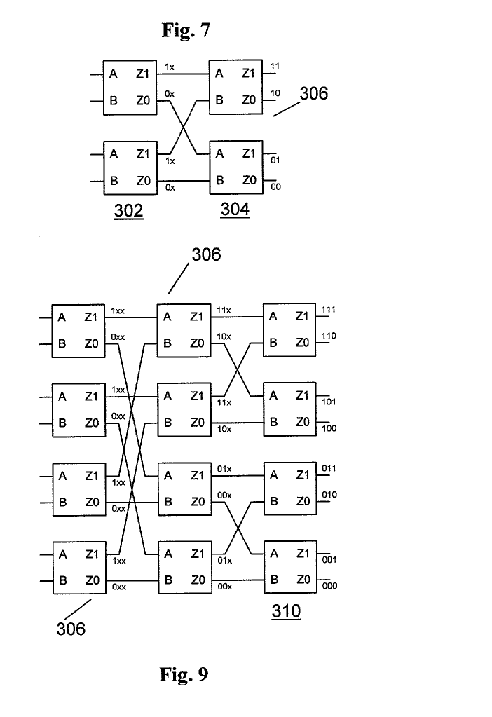

Switches 100 or 101 can be self-selecting and self-arbitrating (i.e., they can operate without external control) if the routing signals and the data signals are sent in a block, or some other type of associated relationship. FIG. 6 illustrates switch 101 with additional circuitry 300, 302 to analyze incoming signals and to extract routing address (RA and RB) and data signals in the data stream. Analyzers 300 and 302 recognize routing signals in the data stream (preferably embedded in the leading edge of the data stream, although the address may be distinct from, related to, or otherwise embedded in the data signal), either independently or with the aid/control of ACK_A and ACK_B, and generate routing signals for switch 101. The data signals, either in original form or preferably with the routing address removed therefrom, proceed along data paths A_DATA and B_DATA and become routed to switch outputs Z0, Z1 as discussed above. Analyzers 300 and 302 may simply connect a SELECT output to the route input of switch 101, although more complicated formats can be used.

In the case of a data stream, an additional rail path can be added to create a terminating signal that marks the end of a data stream. Once switch 101 grants the data stream a path, it maintains that path until analyzer 300 or 302 encounter a terminating condition. Analyzer 300 and/or 302 respond by readying to be cleared by the next incoming acknowledge signal (which indicates that a terminating signal has been successfully transmitted to the next stage downstream of the switch network or to the desired output of the switch network), and then returns its SELECT output to NULL upon receipt of the acknowledge. Any other data path will then be allowed to route its data stream, which resolves any existing collision.

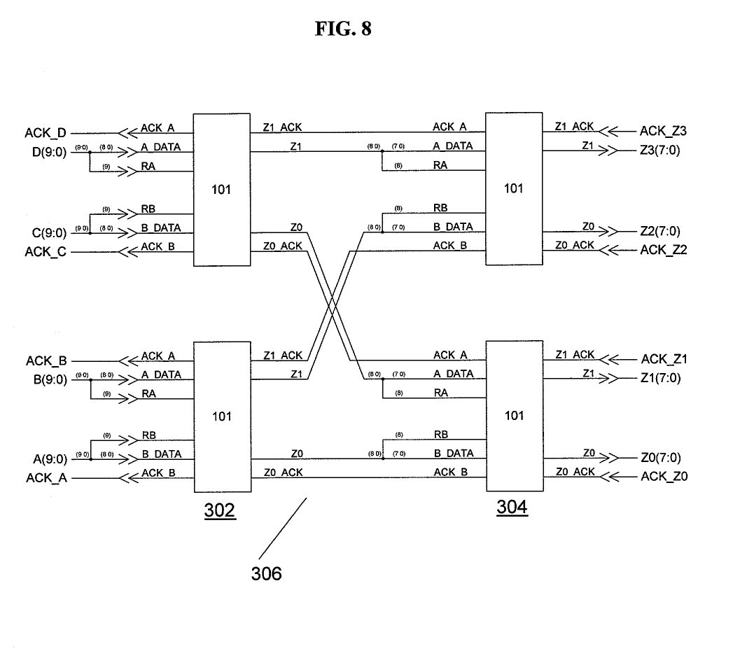

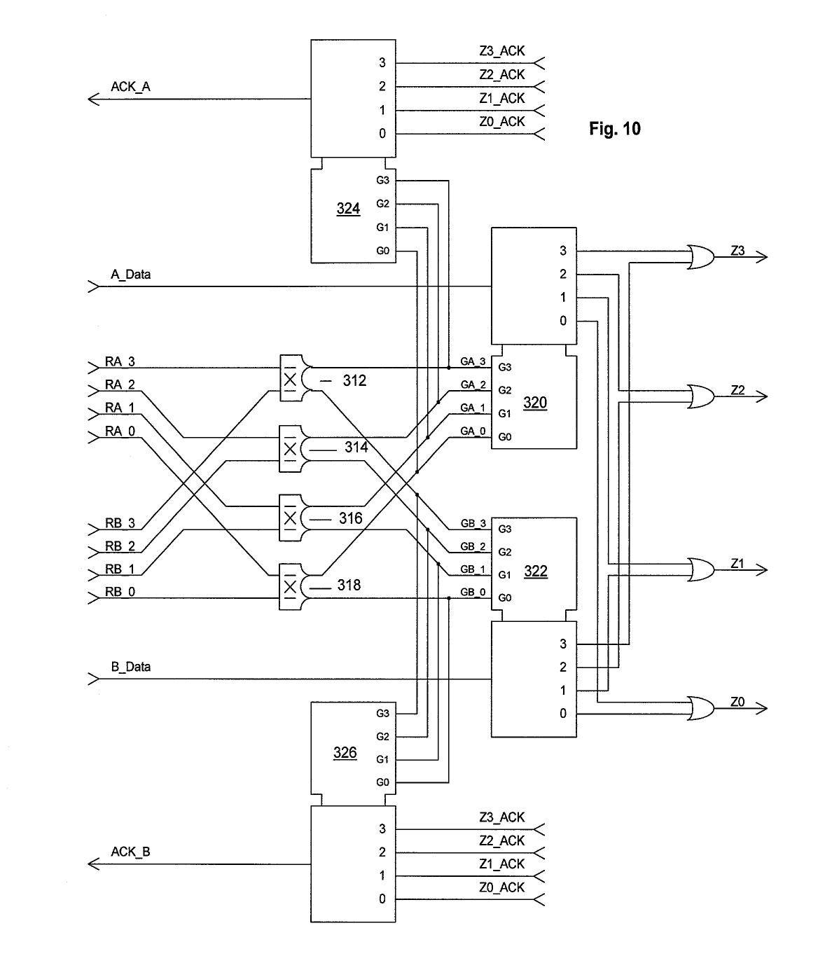

Groups of 2×2 switches can be used to create an N×N self-steering switch. FIGS. 7 and 8 show a 4×4 self-steering network 306. The outputs of the first stage 302 (represented schematically as a column of 2×2 switches) cross-connect to the inputs of the next stage 304 of 2×2 switches. FIG. 9 illustrates two 4×4 switches 306 and an additional stage 310 of four 2×2 switches cross-connected to form an 8×8 switch. Preferably, the routing address for each switch is part of the data stream, such that the switching network can operate without external control, and particularly without the presence of a clock or clocked logic. It is noted that the appearance of the individual switches in row/column format is for illustrative purposes only.

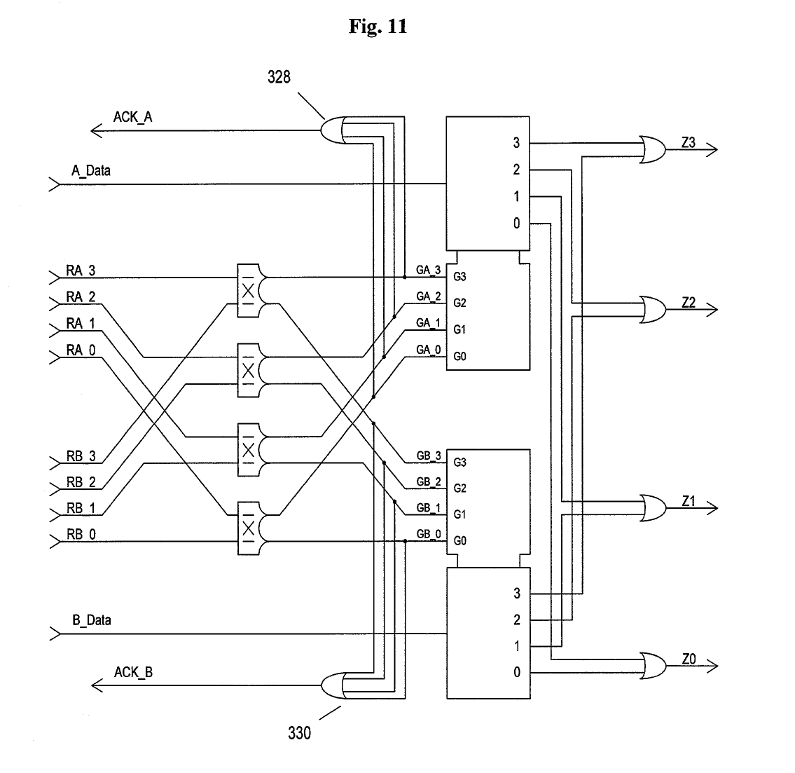

FIG. 10 illustrates a 2×4 switch having two (2) data (A_DATA, B_DATA), two routing inputs (RA and RB) and four (4) outputs Z0-Z3. In this embodiment, rail paths RA and RB are quad-rail paths. An ASSERTED state on any of the rail paths represents a request to send incoming data to a corresponding output (e.g., ASSERTED on RA2 is a request to send data on path A_Data to output Z2). Each of the rail paths cross connects to one dedicated mutex 312, 314, 316, 318, and the outputs of the mutexes cross-connect to two data demultiplexers 320, 322 and two acknowledge multiplexes 324, 326. The operation of the circuit otherwise parallels that of FIG. 3. FIG. 11 shows a similar circuit with OR gates 328, 330 to create acknowledge signals that represent acknowledgement of the selection of the output path.

The foregoing examples have been provided merely for the purpose of explanation and are in no way to be construed as limiting of the present invention. While the present invention has been described with reference to certain embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A switch for routing information to one of a first and second outputs, respectively, comprising:
first and second multi-rail control paths;
first and second mutex gates, said first and second multi-rail control paths being cross connected into said first and second gates;
first and second demultiplexers, outputs of said first and second mutex gates being cross connected into said first and second demultiplexers; and
first and second data paths input to said first and second demultiplexers, respectively;
wherein data on at least one said first and second data paths is routed to one of said first and second outputs based upon a state of said outputs of said first and second mutex gates.

2. The switch of claim 1, wherein when said first and second multi-rail control paths have substantially simultaneously pending signals requesting to route data on said first and second data paths to different outputs, then said signals are simultaneously routed without collision.

3. The switch of claim 1, wherein when said first and second multi-rail control paths collide by substantially simultaneously receiving signals requesting to route data on said first and second data paths to an identical output of said first and second outputs, then data on one of the first and second signal paths randomly passes to said identical output before data on the other of said first and second data paths.

4. The switch of claim 1, wherein when said first and second multi-rail control paths have substantially simultaneously pending signals requesting to route data on said first and second data paths to an identical output of said first and second outputs, then data associated with the first to arrive of the first and second control paths passes to said identical output before data associated with the last to arrive of said first and second control paths.

5. The switch of claim 1, further comprising:
a data stream on said first data path, said data stream including information and a routing address corresponding to a desired one of said first and second outputs; and
an extractor capable of routing said routing address to said first multi-rail input, and routing said information to said first data path.

6. The switch of claim 1, wherein said first and second data paths are multi-rail paths.

7. The switch of claim 1, further comprising:
a downstream circuit capable of generating a first acknowledge signal responsive to data on said first data path reaching said downstream circuit.

8. A switch for routing information to one of n outputs, comprising:
first and second n-rail control inputs;
n mutex gates, each j^{th} path of said first and second n rail control inputs being connected into each jth one of said n mutex gates;
first and second demultiplexers, outputs of said n mutex gates being cross connected to said first and second demultiplexers; and
first and second data paths input to said first and second demultiplexers, respectively;
wherein data on at least one said first and second data paths is routed to one of said n outputs based upon a state of said outputs of said n mutex gates.

9. The switch of claim 8, wherein said first and second data paths are multi-rail paths.

10. The switch of claim 8, further comprising:
a first extractor having a data stream input, an information output, and a routing address output;
said data stream input being connected to an upstream circuit;
said information output being connected to said first data path; and
said routing address output being connected to said first n-rail control paths.

11. The switch of claim 8, wherein said first extractor is capable of separating information and a routing address from an incoming data stream.

12. The switch of claim 10, wherein a state of said control data output remains unchanged until said extractor receives an acknowledge signal, said acknowledge signal representing that information on said information output has reached a desired destination.

13. The switch of claim 1, further comprising first, second, third, and fourth switches, the outputs of said first and second switches being cross connected with the inputs of said third and fourth switches.

14. The switch of claim 1, wherein said switch does not receive a clocked signal.

15. A method for routing signals through a switch, the method comprising:
receiving a plurality of data streams;
detecting, in each data stream, a routing address representing a request to pass that data stream to a desired destination;
routing each data stream consistent with the respective routing address in the order received;
routing at least two of the data streams to different destinations substantially simultaneously when the at least two data streams are substantially simultaneously received and the respective desired destinations are different; and
routing, when the at least two data streams are substantially simultaneously received and the respective desired destinations are identical, one of the at least two data streams to the identical destination followed by sending another of the at least two signals to the identical destination.

16. The method of claim 15, wherein the first and second requests are multi-rail signals, and said receiving comprises receiving the multi-rail signals.

17. The method of claim 15, further comprising separating the routing address from the one of the at least two data streams.

18. The method of claim 17, further comprising separating the routing address from the another of the at least two data streams.

19. A method for routing signals through a switching network, the method comprising:
providing a plurality of stages, each stage including at least two switches;
cross connecting the outputs of switches in an upstream one of said stages with inputs to switches in an adjacent downstream one of said stages; and
each switch:
receiving a plurality of asynchronous data streams;
detecting, in each data stream, a routing address representing a request to pass that data stream to a desired destination;
routing each data stream consistent with the respective routing address in the order received;
routing at least two of the data streams to different destinations substantially simultaneously when the at least two data streams are substantially simultaneously received and the respective desired destinations are different; and
routing, when the at least two data streams are substantially simultaneously received and the respective desired destinations are identical, one of the at least two data streams to the identical destination followed by sending another of the at least two signals to the identical destination.

20. The method of claim 19, wherein each switch has two inputs and two outputs to define a two by two switch, and said providing comprises providing two stages, each stage including two switches, to define a four by four-switching network.

21. The method of claim 19, wherein each switch has two inputs and two outputs to define a two by two switch, and said providing comprises providing three stages, each stage including four switches, to define an eight by eight-switching network.

22. The method of claim 19, further comprising sending an acknowledge signal upstream to confirm that a data stream has reached a desired location.
